(19) United States
(12) Patent Application Publication
(10) Pub. No.: US 2022/0089362 A1
(43) Pub. Date: Mar. 24, 2022

(54) DEVICE COMPRISING A RECEPTACLE FOR STORING A LIQUID

(71) Applicant: Jan Franck, Weidenberg (DE)

(72) Inventor: Jan Franck, Weidenberg (DE)

(21) Appl. No.: 17/539,573

(22) Filed: Dec. 1, 2021

Related U.S. Application Data
(63) Continuation-in-part of application No. 16/541,307, filed on Aug. 15, 2019, now abandoned.
Application No. 16/541,307 is a continuation-in-part of application No. 15/111,398, filed on Jul. 13, 2016, now abandoned.

(30) Foreign Application Priority Data
Jan. 14, 2014 (DE) 10 2014 000 191.1

(51) Int. Cl. B65D 88/76; B65D 90/00; B65D 90/10; B65D 88/74; B65D 90/06; B65D 90/02

(52) U.S. Cl. CPC B65D 88/76; B65D 90/008; B65D 90/028; B65D 88/744; B65D 90/06; B65D 90/105

(57) ABSTRACT

The invention refers to an equipment (1) including a container (19) for the storage of a liquid (2) as well as thermal insulation panels (12,13), wherein none of the thermal insulation panels (12,13) is mounted directly on or even in contact with an outer surface of the container (19), wherein a chamber (5) housing the container (19) is delimited by an enclosure (6) consisting of walls (7), a floor (8) and a ceiling (9), and which is accessible through an access opening, either in the form of an entrance opening in one of the walls (7) closeable by a door or in the form of a manhole (11) eccentric to the center of the ceiling (9) and closeable by a lid (10), wherein the lid (10) or the door is thermally insulated at the inner side and is provided with an air-tight sealing all around, and wherein an inner surface of the chamber (5) except the access opening is entirely covered with the thermal insulation panels (12,13) in such a way that a volume of space occupied by the container (19) is smaller than a volume of space delimited by the inner sides of the thermal insulation panels (12,13) at the inner side of the walls (7), the ceiling (9) and the floor (8), leaving a space for maintenance between the outer surface of the container (19) and the thermal insulation panels (12,13) mounted to the inner surface of the chamber (5), which is only filled with air and is free of any liquid or bulk material in order to keep the container and the bottom of the chamber visible for inspection, and wherein the only way for heat to leave the air-filled space for maintenance between the outer surface of the container (19) and the thermal insulation panels (12,13) is through these thermal insulation panels (12,13) and neither besides such thermal insulation panels (12,13) nor through any kind of air duct or acitve or passive venting.

### REFERENCE TO PENDING PRIOR PATENT APPLICATIONS

This patent application:
(i) is a continuation-in-part of pending prior U.S. patent application Ser. No. 16/541,307, filed Aug. 15, 2019 by Jan Franck for DEVICE COMPRISING A RECEPTACLE FOR STORING A LIQUID (Attorney's Docket No. KUCH-74 CIP), which patent application, in turn:
   (a) is a continuation-in-part of prior U.S. patent application Ser. No. 15/111,398, filed Jul. 13, 2016 by Jan Franck for DEVICE COMPRISING A RECEPTACLE FOR STORING A LIQUID (Attorney's Docket No. KUCH-74), which patent application, in turn:
      (1) is a 371 national stage entry of International (PCT) Patent Application No. PCT/IB2015/000021, filed Jan. 14, 2015 by Jan Franck for DEVICE COMPRISING A RECEPTACLE FOR STORING A LIQUID, which in turn claims benefit of:
         (A) German Patent Application No. DE 10 2014 000 191.1, filed Jan. 14, 2014.

The four (4) above-identified patent applications are hereby incorporated herein by reference.

### FIELD OF THE INVENTION

The invention focuses on an equipment including a container for the storage of a liquid.

### BACKGROUND OF THE INVENTION

In many cases a liquid is to be kept and stored at a temperature being different from the surrounding outer temperature level. A known measure for this purpose is cladding the outer surface of the container with insulating materials, which thermally insulate the container together with the liquid contained in it against the external space—for example against a basement room. An example for such an arrangement is shown in DE 92 00 824 U1. However, such containers are in most cases relatively expensive, inter alia also because the outer surface of containers is often curved, for example following cylindrical or calotte-shaped surfaces, so that the insulating material needs to be adapted to such surface in respect of its shape. Furthermore, the insulation on the outer surface of the container hinders a maintenance person from gaining access to the outer surface of the container, especially for inspecting it, for example in view of leakages or rust.

U.S. Pat. No. 4,102,327 discloses a solar heating system with cooperating cooling, wherein a furnace is modeled by a central container for a liquid circulating through solar panels; this container is embedded into an outer receptacle containing stones as a heat storing medium.

Upon request, air circulates over a heat exchanger coupled to such stones, and this heated air is then circulated through some rooms of the building to be heated. At this arrangement, much more heat is stored in the heat storing stones than in the liquid within the central container. This arrangement has a number of drawbacks: First of all, the outer surface of the container is not accessible for inspection due to the stones surrounding it; furthermore, a chamber housing such liquid container and such receptacle for stones does not comprise any thermal insulation and therefore, much heat is dissipated even if no heat is requested.

The same is true for the CN 201 916 993 U. There, a container for a liquid is located inside an underground storage room beneath a building to be heated. The container receives its heat via solar collectors through which the liquid of the container flows. This underground storage room has only a thermal insulation at its ceiling which is at the same time part of the bottom of the ground-floor of the housing. In summer, this thermal insulation prevents that the heat from the underground storage room can get inside the building, and instead the heat is dissipated in the ground that means wasted. In winter, the thermal insulation is removed from the ceiling of the underground storage room to let the heat from the underground storage room flow inside the building because there is no thermal insulation present in this state. Therefore, the heating action cannot be controlled, and at any time, there is a loss of heat through the uninsulated bottom and walls of the underground storage room.

Furthermore, this document uses a standard heat storage tank comprising an insulation directly on its outer surface in order to reduce the heat release to about 1 to 2 kilowatts, as described in the specification of this document.

Furthermore, in U.S. Pat. No. 3,254,702, there is an underground room of a building completely filled with a bulk material as a heat storage material like stones. Embedded inside such stones is a liquid container which is coupled to solar collectors for receiving heat from there. This heat is transferred to the stones and stored as these stones get warm. If heat is required, air is ciculated through pipes which are embedded in these stones, too, and the heated air can then circulate through the rooms to be heated. Due to this circulation of air through the underground room filled with bulk material, there is a permanent heat exchange between this underground room outside the liquid container and the environment of this underground room through the regarding air ducts. Therefore, the insulation of the underground room is bypassed by such air ducts, and hence the insulation is not able to keep the liquid inside of the container at a constant temperature. Although the underground room of the building housing the liquid container is thermally insulated, there is no possibility of maintenance because (i) the regarding room underground is completely filled with stones and (ii) there is no access opening to this underground room. Furthermore, even if a maintenance person would manage to get into this underground room, an inspection of the liquid container would be impossible due to the bulk material covering the liquid container.

US 2011/0108018 A1 discloses a solar based energy conversion apparatus including a solar collection apparatus configured for tracking the sun, a first loop array for channeling a first heat transfer fluid to and from a fluid resevoir operating as a heat sink, a second loop array for channeling a second heat transfer fluid to and from the fluid reservoir for interfacing via a heat exchanger therewith, a third loop array for channeling a third heat transfer fluid to and from the fluid reservoir for interfacing via a heat exchanger therewith. The fluid reservoir is located underground, either in a basement room of a building or buried in the ground nearby a building. In the first embodiment, where the fluid reservoir is located within a basement room, there is neither an insulation, neither at the fluid reservoir itself, nor at the walls of the basement room, and therefore, the heat within the basement room can easily escape through the uninsulated walls of this room. Additionally, there is no access opening provided for a maintenance person allowing him to inspect the fluid container. On the other hand, in the alternative embodiment where the fluid reservoir is buried in the ground, a chamber surrounding the fluid reservoir is completely missing, and therefore, there is no possibility to inspect the fluid container from the outside. The only possibility is to access the interior of the fluid container through a manhole leading from outdoors directly into the interior of the fluid container.

On the other hand, such arrangement would require to empty the fluid reservoir for each inspection.

U.S. Pat. No. 4,340,032 discloses a solar heating system in the form of a subterranean furnace which contains a shell in which a plurality of bricks are arranged in a mass. First of all, this arrangement does not disclose any container for the storing of a liquid, but only a metal shell which is filled with bricks. Therefore, this shell can never be emptied. Furthermore, there is no insulation for this shell, neither directly on the outside of this shell, nor at the walls of the furnace surrounding such shell. Furthermore, although there is an access opening to this furnace through a manhole, the manhole cover is not insulated, too. In other words, the heat in the furnace but outside of the metal shall can escape through all walls, the bottom and the ceiling inclusive of the manhole cover, without any insulation hindering it from such escape. Additionally, the space inside the furnace but outside of the metal shell is not only accessible via the manhole, but is connected to several air conduits, too. These conduits let air from a house or another building circulate into and out of the furnace space outside of the metal shell. So, even if the walls of the furnace were insulated—what is not the case—such insulation would be bypassed by such air conduits.

### SUMMARY OF THE INVENTION

Resulting from these disadvantages of the hitherto known state of the art is the problem initiating the invention of creating a configuration for a container for the storage of a liquid in such a way that the same can be manufactured as economically priced as possible, notwithstanding good thermal insulation, and wherein the thermal insulation shall be as good as possible, while there is a possibility of maintenance access to the liquid container.

For the solution of this problem in connection with a generic container for the storage of a liquid the invention provides for that such container does not exhibit any insulation directly on its outer surface, but is placed inside an accessible chamber that is covered with plate-shape thermal insulation over its entire inside surface.

More specifially, the invention provides an an equipment including a container for the storage of a liquid, especially at a temperature of the liquid above or below an ambient temperature, as well as thermal insulation panels, wherein none of the thermal insulation panels is mounted directly on or even in contact with an outer surface of the container, wherein a chamber housing the container is delimited by an enclosure consisting of walls, a floor and a ceiling, the chamber being arranged such that the outer surface of the enclosed container containing the liquid is accessible for inspection by a maintenance person gaining access through an access opening, which is either in the form of an entrance opening in one of the walls closeable by a door or in the form of a manhole closeable by a lid, wherein the lid or the door is thermally insulated at the inner side and is provided with an air-tight sealing all around, and wherein an inner surface of the chamber is entirely covered with the thermal insulation panels in such a way that a volume of space occupied by the container is smaller than a volume of space delimited by the inner sides of the thermal insulation panels at the inner side of the walls, the ceiling and the floor, leaving space for maintenance between the outer surface of the container and the thermal insulation panels mounted to the inner surface of the chamber, and wherein the only way for heat to leave the space for maintenance between the outer surface of the container and the thermal insulation panels is through these thermal insulation panels and neither besides such thermal insulation panels nor through any kind of air duct or acitve or passive venting.

Thereby plane plates or panels made of thermally insulating materials or with a thermally insulating structural configuration are used, regardless of the type and shape of the container. The inside wall of a chamber or of a room can always be comprised of plane walls, ceilings, and floors, regardless of the shape of a fluid reservoir installed inside it, so that plane plates or panels can easily be attached to the same, for instance by use of adhesive. Preferably all of the inside walls of the chamber accommodating the container as well as its ceiling and its floor are insulated, i.e. are covered with insulating plates.

For insulating materials preferably foamed materials such as foamed polystyrene or poly(1-phenylethan-1,2-diyl) come into consideration, for example in expanded form (EPS) like Styrofoam, or in extruded form (XPS) like Styrodur, the former preferably at walls and/or at the ceiling, the latter preferably on the floor. Furthermore also so-called vacuum insulation panels can be used, at which the actual insulating solid is completely surrounded by an airtight envelope and evacuated so that thermal conductivity is reduced to a minimum. Of course also other substances are conceivable as long as they exhibit sufficient thermal insulation properties.

According to the invention, a person may have access to the outer surface of the liquid container in order to inspect it, if necessary during operation, that means when the liquid container is filled. This allows a check of the liquid container in view of leakages, because at the filled container, any liquid emerging at the outer surface of the container will be found immediately. Such monitoring or inspection is possible, as the chamber is accessible via an access opening, and the size of the chamber is chosen such that it is big enough to walk in also when the container is installed, thus is providing enough room for one person. Furthermore, the space for inspection should be free of any liquid or bulk material, so that the outer surface of the liauid container is completely visible. Additionally, the space for inspection should not be part of any circulating circuit, especially no circuit for a circulating heat transport medium, so that the maintenance person is not exposed to any heat transport medium.

The accessible or walk-in chamber is preferably filled with a gas, for instance with air.

It is recommend that the pressure inside the chamber corresponds to atmospheric pressure.

The invention recommends, that the arrangement should be such that the only way for heat to leave the space for maintenance between the outer surface of the container and the thermal insulation panels is through these thermal insulation panels and neither besides such thermal insulation panels nor through any kind of air duct or acitve or passive venting. On the one hand, this is a measure for an optimum insulation of the liquid inside the container. On the other hand, the complete space between the outer surface of the liquid container and the inner sides of the insulation panels at the bottom, walls and ceiling of the chamber will be at a raised temperature if the liquid stored in the container is at an elevated level. This raised temperature is advantageous to keep the temperature of the stored liquid constant. Therefore, the air in this space inside the chamber and outside of the liquid container should be hermetically sealed as long as no maintenance takes place. Any ventilation of this space should be avoided. This is still more important, as any air entering this space would carry moisture and therefore would cause water condensing inside of the maintenance space. Moisture inside of the chamber could compromise the insulation and could cause rust at metallic surfaces and should therefore be avoided.

The chamber is preferably provided with an entrance, for example in the form of a door, a lid, and/or a manhole. The entrance can be sealed up airtight in closed condition in order to exclude any heat transfer caused by convection. The above mentioned necessity to avoid moisture inside of the chamber is another reason, why a lid or door closing an access opening should be sealed in an air-tight manner, especially by providing a sealing strip around the lateral surface of a door or lid getting in contact with a circumferential surface of the access opening.

The stored liquid may be water, for example hot water in the context of heating or as domestic hot water for kitchen, bathroom and/or WC. Also a cooled liquid like, for example, cold water, which is kept at a pleasant temperature level in summer can be stored in such a container.

The invention is especially appropriate for the storage of liquids containing water as primary component, i.e. water at a weight proportion of 50% or more, for example at a weight proportion of 70 or more, preferably at a weight proportion of 90% or more, in preference at a weight proportion of 95% or more, in particular at a weight proportion of 98% or more, or even at a weight proportion of 99% or more. This inter alia pertains to liquids mixed with special chemicals, for example with a frost protection agent, with rust preventing agents, antioxidants, and/or substances for influencing any other parameter such as viscosity, degree of acidity, boiling point, etc.

Generally also various other liquids can be stored in a container according to the invention when required, for example oils, acids, alkaline solutions or the like, in particular when temperature control of the same is desired.

It is within the scope of the invention that the pressure inside the container is equal to atmospheric pressure, or greater than the latter. Since the container according to the invention is manually or automatically checkable for leakages, it can be operated at internal overpressure without any risk to the groundwater and without any other impairment of the environment.

Preferably, the heat exchange between the insulated chamber and a surrounding environment is restricted to (i) a heat transfer liquid flowing in at least one pipe, the at least one pipe extending through the thermal insulation at the inner side of the chamber between the container and the outside of the chamber, and (ii) an unwanted heat leckage just through the thermal insulation panels at the inner side of the chamber. By the shell of the liquid container, the space in the chamber outside of the liquid container is entirly separated from the space inside the liquid container. While the latter is filled with a liquid, the space outside of the liquid container is filled with a gaeous medium, especially with air. While a heat transfer into and from the cavity of the liquid container is possible by transporting liquid in tubes extending from the environment through the air- or gas-filled space in the chamber to and from the liquid container, no heat transfer should be possible between the air- or gas-filled space in the chamber and the environment, or at least an as less as possible heat transfer.

The walls, bottom and ceiling of the chamber can be made of a capillary open material, especially of a mineral material, in order to allow moisture to escape therethrough.

The thermal insulation panels can be made of a mineral material, too, as such material is rather less susceptible to moisture, especially when the mineral material of the thermal insulation panels comprises capillaries.

If the thermal insulation panels are covered by a vapour barrier, especially at their inner sides facing towards the interior of the chamber, the insulation can be prevented from moisture. For example, a metal foil coukd be used as a vapour barrier.

The invention can be further improved in that the thermal insulation panels are covered by a metal foil or by another barrier for thermal radiation. By doing this, not only a flow of heat to the outside and a convection between the chamber and the environment can be avoided, but also a heat loss by thermal radiation.

If the liquid container is covered by a smooth metal surface and/or by a reflecting metal surface, the thermal radiation of the liquid container will be reduced to a minimum.

In a preferred embodiment, the outer surface of the container should be accessible during normal operation of the container, in order to avoid a heat loss which could be caused by an emptying of the container.

In a preferred embodiment, the height of the container can be greater than its extention in any horizontal direction. Such a dimensioning will correspond to a height of the chamber of at least 1.80 m, so that a maintenance person can stand inside of the chamber.

Preferably, a manhole as acces opening should be located eccentric to the center of the ceiling, in order for a peson climbing into the chamber reaching a ladder or other steps provided at the wall of the chamber.

The chamber according to the invention may be placed belowground, for instance in form of a basement room or of a hermetically closed basement compartment, or in form of a cistern-like cavity underground. By embedding the chamber in soil, particularly below the depth of frost penetration of ca. 80 cm or 100 cm can be achieved that the temperature discharge during the cold season of the year is decreased because of the reduced temperature difference between the inside of the chamber and the ambience. A similar effect is achieved by installation in a basement room, particularly when the same is for the most part or completely located below ground surface.

On the other hand it is also possible to set up the chamber aboveground, for example in form of an (auxiliary) building or in a supply chamber or storeroom preferably on the ground surface, also however in an attic room or the like, as the case may be.

By incorporating it into a building being additionally insulated at its outer surface the insulating effect at the inner side of the camber can be improved even more.

Inside the chamber a ladder can be provided for so that a person can step down inside the chamber. For that purpose indeed also individual rungs could be directly fixed in a surrounding wall of the chamber; however such a measure would produce a large number of thermal bridges, as for each one of such rungs the insulation would have to be disrupted. Therefore it is better to use a ladder with stringers and to affix them at the most at their upper and/or at their bottom ends to the chamber. On the other hand also the alternative exits to directly attach such a ladder or individual rungs at the container itself, because in this way no thermal bridges to the outside would be generated.

The chamber should be equipped with some kind of artificial and/or natural lighting, for example by electric lighting and/or in form of a light well. A light switch for artificial lighting inside chamber could be installed outside the chamber for safety reasons so that no spark formation will occur inside the chamber when switching on or off.

As far as some natural illumination is desired in case of an aboveground chamber, at any rate some part of the chamber could be glazed. In that case however thermo-glass is recommended, therefore a multi-layer arrangement of glass panes, each with vacuum in between the individual panes. In case of an underground chamber a light well would be able to let daylight into the chamber where applicable.

The invention is furthermore distinguished by a heating unit for raising the temperature of the stored liquid, and/or by a cooling device for lowering the temperature of the stored liquid. For that purpose installation of a heat exchanger near the container or just inside the chamber will suffice; the actual heat generation or heat production may take play outside of it.

The heating and/or cooling facility, or anyhow a heat exchanger of the same, should be placed inside the walkable chamber in such a way that it is enclosed by the plate-shaped thermal insulation attached to the inner sides of the chamber walls. Therefore the brought in heat cannot escape to the outside, or thermal energy discharged for cooling purposes cannot penetrate into the chamber again respectively.

Preferentially heat exchanger of a heating unit and/or of a cooling device is placed inside the chamber and/or the container is at least component part of a heat pump or some other heat circulation system, for example of a solar collector heat circulation system, for transporting thermal energy either into the chamber or into the container, or for discharging it from there. The respective other heat exchanger of a heat circulation system is thereby arranged outside of the chamber, or anyway outside of the container according to the invention.

The invention may be expanded to the effect that at least one heating unit and/or a cooling device is component part of a temperature control circuit in order to regulate the temperature of the liquid inside the container to a specified temperature value, or to keep it within a range of permissible temperature values. By such measure can be assured that the temperature of the liquid inside the container always conforms to permissible values, for instance also then when a liquid quantum to be replenished initially exhibits a different temperature than the stored liquid.

On the other hand can at least one heating unit and/or cooling device be component part of a temperature control circuit in order to regulate the temperature of the air inside the chamber to a specified temperature value, or to keep it within a specified range of temperature values. When the temperature inside the thermally insulated area of the chamber is kept at the same level as the setpoint temperature of the liquid inside the container set up in it, the heat dissipation from the accordingly tempered liquid through the wall of the container equals zero.

For the purposes of temperature monitoring and/or control a temperature sensor should be installed in the walkable room of the chamber outside of the container. With this for example a fan inside the chamber could be activated to equalize the air temperature within the camber in case of overheating in winter or in case of temperature being too low during the warm season of the year.

Besides a leakage sensor can be installed in the walkable room of the chamber outside of the container, for example a sensor detecting the liquid stored inside the container. A preferred place for such a sensor for instance would be in a “sump” embedded in the floor of the chamber, thus there where leaking liquid would accumulate. For that purpose the floor could perhaps be finished with a slant towards one corner of the chamber, where then the liquid detection sensor would be located.

Finally it conforms to the teaching of the invention that in the walkable room of the chamber outside of the container a pressure sensor is installed. Thereby a defect in liquid tightness of the container could be detected, in particular in case of a pressure vessel and a sealed-up entrance at the same time.

### BRIEF DESCRIPTION OF THE DRAWING

Additional characteristics, details, advantages, and effects on the basis of the invention arise from the following description of a preferred embodiment of the invention as well as by reference to the drawing, wherein:

FIG. 1 represents a vertical section through an equipment according to the invention for the storage of a liquid to be kept at temperature.

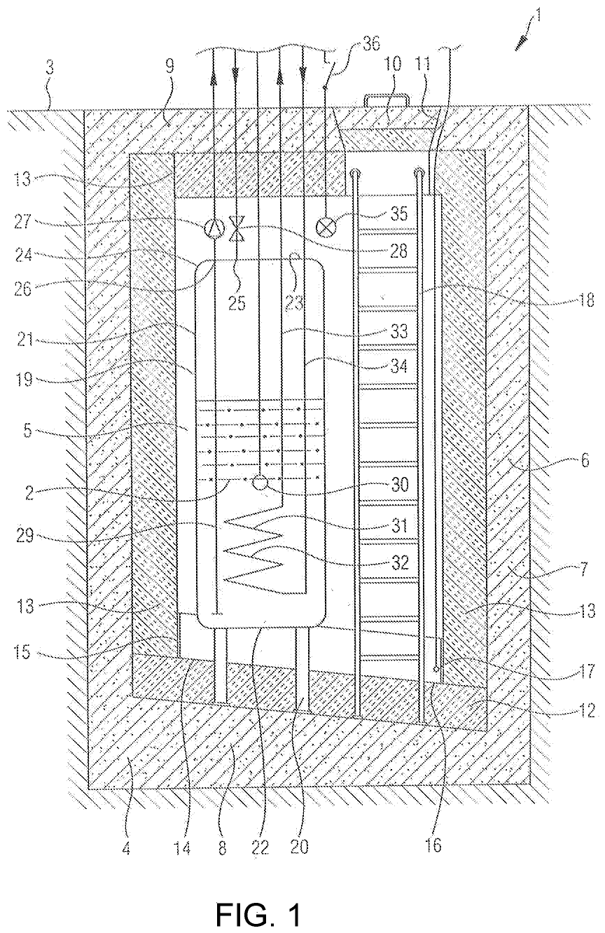

### DETAILED DESCRIPTION OF THE PREFERRED EMBODIMENTS

The equipment 1 for the storage of a liquid 2 to be kept at temperature exemplarily represented by the drawing may be located below the ground surface 3. However this is not mandatory. The entire arrangement could—with the exception of a foundation 4 or some other substructure—also be placed above the ground surface 2.

A distinctive characteristic of the equipment 1 according to the invention is a chamber 5, which is delimited by an enclosure 6.

This enclosure 6 preferably consists of walls 7, a floor 8, and a ceiling 9. Walls 7, floor 8, and ceiling 9 should be planar and are preferably at least self-supporting. For these purposes multifarious materials providing sufficient stability come into question. Preferred however are building materials such as bricks, stone, or concrete; of course also other materials are principally possible like plastics, metals, or even wood, although such materials are generally inferior to inorganic, nonmetallic building materials in respect of stability and/or durability.

The floor 8 of the enclosure 6, respectively the upper surface of the foundation 4 can be finished with a slight slant inside the chamber in order to form some sort of a sump at its lowermost point for collecting leaking liquid 2 or the like.

Above the highest point of a possibly slanted running floor 8 the chamber 5 has a constant or invariable horizontal cross section all the way up to the inner surface of the ceiling 9. This horizontal cross section is preferably of polygonal shape with straight sides, for example has a rectangular or quadratic perimeter.

Principally of course also a prismatic geometry is imaginable, although this is not even promotive for further mounting and installation.

The walls 7 could be made up of several ring-like structural components that are stacked on top of one another, each with polygonal perimeter corresponding to the invariable horizontal cross section of the chamber 5; such ring-like structural components each could consist of concrete and could be provided with circumferential groove and/or tongue type indentations and raised sections at their top and bottom sides complementary to each other, providing for reciprocal centering.

On the other hand could also be imagined to build at least some parts of the walls 7 of vertically erected slabs of concrete. A conventional way of construction of the walls 7 using bricks or stones is of course also thinkable.

The walls 7 terminate at their upper ends in a preferably horizontal ceiling 9, for example made of concrete.

In case of a belowground embodiment the ceiling 9 is preferably provided with an access opening, for example in form of a lid 10 that closes up some sort of a manhole 11.

In case of aboveground embodiments preferably an access door in a wall 7 is provided.

An entrance—thus a lid 10 or a door—can be provided with a sealing all the way around to ensure that the chamber 5 is to a great extend closed up airtight in closed condition. In case of the access opening being closed, there should be no air or gas convection between the insulated space within the chamber 5 and the outside.

An access entrance is either not lockable, or can at least anytime be opened from the inside.

At the inner side of the enclosure 6 thermal insulation is envisaged, particularly in form of thermally insulating panels 12, 13.

These can be made of different materials, for example foamed material such as Styrofoam or Styrodur.

The floor is preferably covered up with plate-type Styrodur material 12, the walls with plate-type Styrofoam material 13.

Other materials are imaginable, for example so-called vacuum insulation panels, in which a foamed or open-pored core is surrounded by an airtight envelope and then evacuated so that heat transfer due to convection cannot occur.

The thickness of insulating panels 12, 13 depends to a certain degree on their thermal insulation properties. While for conventional insulation plates without vacuum a thickness of 5 cm or more is recommended, preferably of 10 cm or more, may for vacuum insulation panels a thickness of 1 cm or more already be sufficient, or a thickness of 2 cm or more.

A lid 9 or an access door is preferably also thermally insulated at the inner side.

On top of the of insulating panels 12 attached to the floor, a liquid-impermeable layer 14 may be provided, for instance in form of sheet metal with a folded-up rim 15. This layer 14 serves the purpose of guiding leaking liquid to a deepest point or sump 16 at the floor and to accumulate it there. There a liquid detection sensor 17 can be installed for setting off an alarm in the event of a leakage.

Preferably, the height of the chamber 5 is greater than any horzontal extension of the chamber 5. This shape facilitates a person standing within the chamber for maintenance.

For the same reason, the volume of space occupied by the container 19 should be for at least 1.5 m³ smaller than the volume of space delimited by the thermal insulation panels 12,13 at the inner side of the enclosure 6 of the chamber 5, preferably for at least 2 m³ smaller, especially for at least 2.5 m³ smaller. This gives a person enough space for conducting maintenance work within the chamber 5.

On the other hand, the space delimited by the thermal insulation panels 12,13 at the inner side of the enclosure 6 of the chamber 5, outside of the container 19, should be smaller than 6 m³, preferably smaller than 5 m³, especially smaller than 4 m³. A rather small space within chamber 5 besides the container 19 ensures that no much heat is dissipated from the container 19 into the isolated space within chamber 5.

So. the chamber 5 is walkable through the access opening—thus through a manhole 11 with lid, or through a door.

In case of an access opening in the ceiling as demonstrated on the drawing a ladder 18 is provided below the manhole 11 so that operating or maintenance personnel can stepdown into the chamber 5. The ladder 18 is at the most at its upper and/or bottom stringer ends affixed to the walls/ceiling/floor of chamber in order to minimize heat bridges going straight through the insulating plates 12, 13.

Preferably is a manhole 11 together with the ladder 18 running beneath it not arranged at the center of the ceiling 9, but is offset towards the periphery of the chamber 5, therefore near a wall 7.

In the case of an access door, or when entering the chamber 5 is not required, a ladder 18 is superfluous.

Beside it there is enough space inside the chamber 5 for the installation of a container 19, for example in form of a tank. The container is preferably freestanding within the chamber 5 and is supported by feet 20 or some other base structure that are reaching though the insulating plates 12 on the floor and are resting on a solid floor 8 or on a foundation 4. Openings reaching through a liquid-impermeable layer 14 can be sealed up.

The horizontal cross section of the container 19 can suitably be chosen to match the horizontal inside cross section of the chamber 5, for example can itself be rectangular when the chamber has a square cross section, of course also with rounded edges where applicable. At the other hand this is not mandatory and therefore in a chamber 5 with a square cross section for example also a container 19 with a round cross section can be installed.

The container 19 itself does not need any insulation and therefore can consist of just one layer of a stiff material, for example of sheet metal.

A shell 21 of the preferably vertical standing container 19 is closed at the bottom by a bottom element 22, and at the top by a cap or a top cover 23. These parts can either directly or by way of bent transition sections 24 be welded together, or can be connected together liquid-tight in any other way.

The container 19 may consist of only one single shell 21, or of a double shell 21 comprising two shells which are concentric to each other and only have a maximum distance of 5 cm or less, preferably a maximum distance of 2 cm or less, especially a maximum distance of 1 cm or less. wherein the container 19 consists of a double shell with two shells concentric to each other, the space between the two shells shall be filled with air only, preferably with a pressure lower than the atmospheric pressure.

The shell 21 of the container 19 shall not be in contact with mineral or organic or bulk material, neither inside the container nor outside the container, only with the exception of its mounting sites at the floor, walls or ceiling of the chamber 5, where such contact is necessary. Such material would take much of the heat from the container 19 and therefore is not desirable.

For the same reason, the space delimited by the thermal insulation panels 12,13 at the inner side of the enclosure 6 of the chamber 5, especially outside of the container 19, should be entirely free of mineral or organic or bulk material, especially of heat storage solids, in paricular of bulk heat storage solids with a heat storage capacity of 0.7 kJ kg⁻¹ K⁻¹ or more. Such embodiment has several advantages: On the one hand, there is less heat dissipated from the container into the space of the chamber, because the air in the hollow space has very low thermal capacity, much less than solid material, especially very much less than heat storage material. On the other hand, an empty space allows a person more room for maintenance. Finally, if the chamber 5 is opened and thereby vented through the access opening, less heat is lost.

Inside the container 19 is the liquid 2 to be stored, for example water or a substance consisting mainly from water. For inflow and outflow of liquid the container 19 has an inflow opening 25 and an outflow opening 26, to which in each case a pipe can be connected, either directly or via one or more interconnected armatures such as pumps 27, valves 28, shutoff dampers, flowmeters, or the like. Such inlet or outlet pipes extend through the thermal insulation panels 12,13 at the inner side of the enclosure 6 of the chamber 5 between the inlet 25 or outlet 26 of the container 19 and the outside of the chamber 5. Thereby, these inlet and/or outlet pipes extend through the enclosure 6 of the chamber 5, too.

In the case of the equipment 1 represented on the drawing a valve 28 is connected at the inflow opening 25, and a pump 27 is connected at the outflow opening 26.

The inflow opening 25 runs preferably in the area of the upper top cover 23 into the container 19.

As far as the outflow opening 26 is also located in the area of the upper top cover 23 of the container 19, a suction pipe 29 reaching all the way down inside the container 19 close to the bottom 22 should be provided so that the pump 27 does not run dry until the container 19 is emptied to a great extent.

Furthermore a filling level sensor 30 can be installed inside the container 19, which either monitors one or more specified filling level threshold values, or detects the actual filling level and transmits it in form of a measured value to an evaluation, regulating and/or control system.

Inside the container 19A, a heating unit for raising the temperature of the liquid 2 stored inside the container 19, and/or a cooling device for lowering the temperature of the liquid 2 stored inside the container 19 may be installed.

Such heating unit and/or cooling device can have the form of a heat exchanger 31 installed within the container 19 and traversed by a heat transfer liquid circulating through the heat exchanger.

More specifically, such heat exchanger 31 inside the container 19 can be designed in the form of a heat exchange pipe installed within the container 19 and traversed by the heat transfer liquid circulating through the heat exchange pipe.

Even more specifically, such heat exchange pipe inside the container 19 may have the form of a heat exchange coil 32 installed within the container 19 and traversed by the heat transfer liquid circulating through the heat exchang coil.

Such heat exchanger 31 or heat exchange pipe or heat exchange coil is placed directly inside the container 19 for a good thermal contact in order to provide for the right temperature of the liquid 2 inside the container 19, thus to heat it up or to cool it down.

The heat exchanger 31 preferably has the shape of a pipe wound to a helical coil 32, which is for example coiled around a vertical helical coil axis.

At both ends of the heat exchanger 31 respectively of the helically coiled pipe section 32 two circulating pipes 33, 34 are connected, which are leaving the container 19, preferably at its topside 23. Such circulating pipes 33,34 extend through the thermal insulation at the inner side of the enclosure 6 of the chamber 5 between the container 19 and the outside of the chamber 5. Thereby, these circulating pipes 33,34 extend through the enclosure 6 of the chamber 5 to the outside of the chamber 5. Via the flow temperature and/or the flow velocity of the heat transfer medium inside the circulating pipes 32, 33, 34 the heat input or heat removal into respectively from the container 19 can be regulated or controlled.

Furthermore, at least one of the heating unit and/or the cooling device can be part of a temperature control circuit for regulating the temperature of the liquid 2 inside the container 19 to a specified temperature value, or for keeping the temperature within a specified range of permissible temperature values. For temperature control a temperature sensor can be installed inside the container 19, preferably in its lower section and/or near the opening of a suction pipe 29.

The heating unit and/or the cooling device according to the present invention can be a part of a heat pump or a part of a solar collector heat circulation system, in order to transport thermal energy either into the chamber 5 and/or into the container 19, or for discharging the same from there.

Further sensors can be provided for in addition. In the chamber 5 outside of the container 19 for example a temperature sensor can be installed, so that also the space inside the chamber 5, but outside of the container 19 can be temperature controlled or at least monitored.

Moreover a pressure sensor cold be installed so that particularly in case of a pressurized storage container 19 in combination with a sealed access opening or manhole 11 some leakage of the container 19 can be detected on the basis of raising pressure inside the chamber 5.

In addition also various other parameters could be monitored by additional sensors, for example a development of toxic vapors or gases, etc.

At least one preferably electrical light source 35 is envisaged inside the chamber 5, which can be electrically activated by a light switch 36, preferably by a light switch 36 being installed outside of the chamber 5.

Finally, the heat exchange between the insulated chamber 5 and its surrounding is restricted to (i) a heat transfer liquid flowing in at least one pipe, the pipe extending through the thermal insulation at the inner side of the chamber 5 between the container 19 and the outside of the chamber 5, and possibly (ii) an unwanted heat leckage just through the thermal insulation panels 12,13 at the inner side of the chamber 5. This is in conformity with the intention of the invention to store the thermal energy within the container inside the chamber for a controlled use by an inhabitant of the regarding building, and not to let the energy getting dissipated or wasted. Therefore, the amount of unwanted heat leckage is as low as possible; therefore, the thermal flow through the thermal insulation panels 12,13 should be as low as possible, too. Ideally, the only permitted heat exchange between the insulated chamber 5 and its surrounding should be by one or several heat transfer liquids like water, for example, flowing in at least one pipe through the thermal insulation at the inner side of the enclosure of the chamber 5.

### LIST OF REFERENCE SIGNS

| | |
|---|---|
| 1 | Equipment |
| 2 | Liquid |
| 3 | Ground surface |
| 4 | Foundation |
| 5 | Chamber |
| 6 | Enclosure |
| 7 | Walls |
| 8 | Floor |
| 9 | Ceiling |
| 10 | Lid |
| 11 | Manhole |
| 12 | Insulation plates |
| 13 | Insulation plates |
| 14 | Layer |
| 15 | Rim |
| 16 | Sump |
| 17 | Liquid sensor |
| 18 | Ladder |
| 19 | Container |
| 20 | Feet |
| 21 | Shell |
| 22 | Floor |
| 23 | Top cover |
| 24 | Transition section |
| 25 | Inflow opening |
| 26 | Outflow opening |
| 27 | Pump |
| 28 | Valve |
| 29 | Suction pipe |
| 30 | Filling level sensor |
| 31 | Heat exchanger |
| 32 | Helically coiled pipe section |
| 33 | Pipe |
| 34 | Pipe |
| 35 | Light source |
| 36 | Switch |

What is claimed is:

1. An equipment (1) including a container (19) for the storage of a liquid (2), especially at a temperature of the liquid above or below an ambient temperature, as well as thermal insulation panels (12,13), wherein none of the thermal insulation panels (12,13) is mounted directly on or even in contact with an outer surface of the container (19), wherein a chamber (5) housing the container (19) is delimited by an enclosure (6) consisting of walls (7), a floor (8) and a ceiling (9), the chamber being arranged such that the outer surface of the enclosed container (19) containing the liquid (2) is accessible for inspection by a maintenance person gaining access through an access opening, which is either in the form of an entrance opening in one of the walls (7) closeable by a door or in the form of a manhole (11) in the ceiling (9) closeable by a lid (10), wherein the lid (10) or the door is thermally insulated at the inner side and is provided with an air-tight sealing all around, and wherein an inner surface of the chamber (5) except the access opening is entirely covered with the thermal insulation panels (12,13) in such a way that a volume of space occupied by the container (19) is smaller than a volume of space delimited by the inner sides of the thermal insulation panels (12,13) at the inner side of the walls (7), the ceiling (9) and the floor (8), leaving a space for maintenance between the outer surface of the container (19) and the thermal insulation panels (12,13) mounted to the inner surface of the chamber (5), and wherein the only way for heat to leave the space for maintenance between the outer surface of the container (19) and the thermal insulation panels (12,13) is through these thermal insulation panels (12,13) and neither besides such thermal insulation panels (12,13) nor through any kind of air duct or acitve or passive venting.

2. The equipment (1) according to claim 1, wherein the heat exchange between the insulated chamber (5) and a surrounding environment is restricted to (i) a heat transfer liquid flowing in at least one pipe, the at least one pipe extending through the thermal insulation at the inner side of the chamber (5) between the container (19) and the outside of the chamber (5), and (ii) an unwanted heat leckage just through the thermal insulation panels (12,13) at the inner side of the chamber (5).

3. The equipment (1) according to claim 1, wherein the walls, bottom and ceiling of the chamber are made of a capillary open material, especially of a mineral material.

4. The equipment (1) according to claim 1, wherein the thermal insulation panels (12,13) are made of a mineral material.

5. The equipment (1) according to claim 1, wherein the mineral material of the thermal insulation panels (12,13) comprises capillaries.

6. The equipment (1) according to claim 1, wherein the thermal insulation panels (12,13) are covered by a vapour barrier.

7. The equipment (1) according to claim 1, wherein the thermal insulation panels (12,13) are covered by a metal foil or by another barrier for thermal radiation.

8. The equipment (1) according to claim 1, wherein the container is covered by a smooth metal surface and/or by a reflecting metal surface.

9. The equipment (1) according to claim 1, wherein the outer surface of the container is accessible during normal operation of the container.

10. The equipment (1) according to claim 1, wherein the height of the container is greater than its extention in any horizontal direction.

11. The equipment (1) according to claim 1, wherein any airflow between the air- or gas-filled chamber and the outside is prevented, especially by completely closing the walls, bottom and ceiling and the gap between a door or manhole and the wall or ceiling.

12. The equipment (1) according to claim 1, wherein in case of the access opening being closed, there is no air or gas convection between the insulated space within the chamber (5) and the outside.

13. The equipment (1) according to claim 1, wherein the container (19) comprises an inlet (25) and/or an outlet (26), which are connected via inlet and/or outlet pipes, which extend through the thermal insulation panels (12,13) at the inner side of the enclosure (6) of the chamber (5) between the container (19) and the outside of the chamber (5).

14. The equipment (1) according to claim 1, wherein a heating unit for raising the temperature of the liquid (2) stored inside the container (19), and/or a cooling device for lowering the temperature of the liquid (2) stored inside the container (19) is installed within the container (19).

15. The equipment (1) according to claim 14, wherein the heating unit and/or the cooling device is in the form of a heat exchanger installed within the container (19) and traversed by a heat transfer liquid circulating through the heat exchanger.

16. The equipment (1) according to claim 15, wherein the heat exchanger inside the container (19) is in the form of a heat exchange pipe installed within the container (19) and traversed by the heat transfer liquid circulating through the heat exchange pipe.

17. The equipment (1) according to claim 16, wherein the heat exchange pipe inside the container (19) is in the form of a heat exchange coil installed within the container (19) and traversed by the heat transfer liquid circulating through the heat exchang coil.

18. The equipment (1) according to claim 15, wherein the heat exchanger is connected via circulating pipes (33,34), which extend through the thermal insulation at the inner side of the enclosure (6) of the chamber (5) between the container (19) and the outside of the chamber (5).

19. The equipment (1) according to claim 14, wherein at least one of the heating unit and/or the cooling device is part of a temperature control circuit for regulating the temperature of the liquid (2) inside the container (19) to a specified temperature value, or for keeping the temperature within a specified range of permissible temperature values.

20. The equipment (1) according to claim 14, wherein at least one of the heating unit and/or the cooling device is part of a heat pump or is part of a solar collector heat circulation system, in order to transport thermal energy either into the chamber (5) and/or into the container (19), or for discharging the same from there.

21. The equipment (1) according to claim 1, wherein the container (19) is not in contact with mineral or organic material, only with the exception of a plurality of mounting sites at the floor, walls or ceiling of the chamber (5).

22. The equipment (1) according to claim 1, wherein the container (19) is not in contact with mineral or organic or bulk material, neither inside the container nor outside the container, only with the exception of a plurality of mounting sites at the floor, walls or ceiling of the chamber (5).

23. The equipment (1) according to claim 1, wherein the container (19) consists only of a single shell, or of a double shell with two shells which are concentric to each other and only have a maximum distance of 5 cm or less, or a maximum distance of 2 cm or less, or a maximum distance of 1 cm or less.

24. The equipment (1) according to claim 23, wherein the container (19) consists of a double shell with two shells concentric to each other, where the space between the two shells is only filled with air, or with air at a pressure lower than the atmospheric pressure.

25. The equipment (1) according to claim 1, wherein the space delimited by the thermal insulation panels (12,13) at the inner side of the enclosure (6) of the chamber (5), inside and/or outside of the container (19), is free of bulk heat storage solids, or of bulk heat storage solids with a heat storage capacity of 0.7 kJ kg⁻¹ K⁻¹ or more.

26. The equipment (1) according to claim 1, wherein the height of the chamber (5) is greater than any horzontal extension of the chamber (5).

27. The equipment (1) according to claim 1, wherein the volume of space occupied by the container (19) is for at least 1.5 m³ smaller than the volume of space delimited by the thermal insulation panels (12,13) at the inner side of the enclosure (6) of the chamber (5), or for at least 2 m³ smaller, or for at least 2.5 m³ smaller.

28. The equipment (1) according to claim 1, wherein the space delimited by the thermal insulation panels (12,13) at the inner side of the enclosure (6) of the chamber (5), outside of the container (19), is smaller than 6 m³, or smaller than 5 m³, or smaller than 4 m³.

29. The equipment (1) according to claim 1, wherein the inside wall surfaces of the chamber (5) are provided with planar walls (7), a planar ceiling (9) and/or a planar floor (8).

30. The equipment (1) according to claim 1, wherein the material of the thermal insulation panels (12,13) comprises foamed polystyrene, or expanded polystyrene (EPS) or extruded polystyrene (XPS).

31. The equipment (1) according to claim 1, wherein all or some of the thermal insulation panels (12,13) comprise vacuum insulation panels, at which an actual insulating solid is completely surrounded by an airtight envelope and evacuated so that thermal conductivity is reduced.

32. The equipment (1) according to claim 1, wherein the chamber (5) is placed belowground, or is in the form of a basement room or of a hermetically closed basement compartment, or in the form of a cavity under the ground surface (3).

33. The equipment (1) according to claim 1, wherein a ladder (18) is provided inside the chamber (5) so that a person can step down inside the chamber (5).

34. The equipment (1) according to claim 1, wherein a temperature sensor and/or a leakage sensor and/or a pressure sensor is installed in the chamber (5) outside of the container.

35. The equipment (1) according to claim 1, wherein an access opening in the form of a manhole (11) is located eccentric to the center of the ceiling (9).
